(19) United States
(12) Patent Application Publication
(10) Pub. No.: US 2024/0161133 A1
(43) Pub. Date: May 16, 2024

(54) SYSTEM FOR AND METHOD OF DETERMINING USER INTERACTIONS WITH SMART ITEMS

(71) Applicant: Farfetch UK Limited, London (GB)

(72) Inventors: Melissa Nicole Lim, London (GB); Pedro Jorge Reis Costa, London (GB)

(21) Appl. No.: 18/551,840

(22) PCT Filed: Mar. 24, 2022
(86) PCT No.: PCT/GB2022/050743

§ 371 Date: Sep. 21, 2023

(30) Foreign Application Priority Data
Mar. 24, 2021 (GB) 2104159.5

(51) Int. Cl. G06Q 30/0201; G06K 7/10; G06Q 20/20

(52) U.S. Cl. CPC G06Q 30/0201; G06K 7/10297; G06Q 20/20

(57) ABSTRACT

A system for determining a user's interactions with an item within an interaction environment is described. The system comprises: a smart tag configured to be securely attached to an item and to sense a user's physical interaction with the item in use, the smart tag including: motion detector configured to detect and differentiate between different types of motion experienced by the smart tag; and a communications engine configured to determine the location of the smart tag within the interaction environment; wherein the communications engine is configured, in use, to transmit interaction information to a receiving device over a short range wireless telecommunications link, the interaction information comprising the location of the smart tag or data enabling the location of the smart tag to be determined, the type of motion experienced by the smart tag over a time period and a unique tag identifier; and a user interaction server remotely located from the interaction environment and connectable to the receiving device via a wide area communications network, the user interaction server being configured to receive the interaction information, the user interaction server being configured to analyse the interaction information to determine the occurrence of a trigger event and in response thereto, to carry out a predetermined action.

### FIELD OF THE DISCLOSURE

The present disclosure relates to system for and a method of determining user interactions with smart items, and more particularly though not exclusively, to user interaction with items in a retail environment, such as a clothing store which have been fitted with smart tracking tags. It is to be appreciated that the term ‘smart item’ is intended to cover any item fitted with a smart tracking tag.

### BACKGROUND

There is a need to be able to track items during user interaction within an interaction environment, for example a retail environment or a warehouse environment. Such user interactions can determine a great deal of information regarding the effectiveness within a retail/warehouse environment of for example:
items placement within that space
layout design of environment to best manage throughput
security regarding preventing theft of items from the environment

Furthermore, there is a need to address the issue that items within the retail/warehouse environment get moved around by customers/users in the normal course of use. For example, in a retail clothing store, an item may be moved by being taken to a mirror or to the changing room as part of the user experience in purchasing that item. Often items are placed back or simply left by the customer in the incorrect location within the store and have to be found and moved back to the correct location by staff. Finding such misplaced items can be a time-consuming manual process and hence there is a desire to track items within this space.

Many of the current tracking solutions are based on systems using computer vision-based machine learning with cameras and weighted shelves. This brings about problems such as:
Cameras are expensive to purchase and install;
Weighted shelves are static and cannot be frequently merchandised;
Huge computer processing is required to aggregate data from the cameras/weighing scales;
Cameras can only detect solid objects such as those found in a supermarket (packaged);
Anonymity of customer images and data is challenged;

Furthermore, systems exist to perform partial tracking as a security measure. Such partial tracking systems are provided as a security measure to alert staff present in the retail environment if an item is being stolen (item being removed from the premises without having the security feature of the tag deactivated or removed by the staff). In this regard, an alarm is activated if the tag on the item passes a set of sensors located at an exit of the premises. However, such systems only provide a limited form of tracking in that they simply alert staff if an item is being removed from the premises, namely if the item is being taken out of the store. They do not track the location of the item within the store and provide no information regarding user interaction with the item.

RFID tags known in retail environment for tracking location of item such as clothing. These tags help to identify an item uniquely at a given location but are entirely passive. One significant problem with such systems is that such tracking requires scanning by a human of the RFID tag as it is moved from location to location. The location is determined by the location of the human rather than independently. Also, such tracking using RFID tags is intermitted and sporadic and not in real-time, in that there is always a delay in knowing the location of an item which relates to the last time the location was scanned in by a sales assistant. In this regard, such prior art methods are cumbersome and often do not work effectively.

Finally, none of the above-described technologies can accurately sense the type of user interaction with the item.

It is desired to overcome or address at least some of the above problems.

### SUMMARY OF THE PRESENT INVENTION

According to one aspect of the present invention there is provided a system for determining a user's interactions with an item within an interaction environment, the system comprising: a smart tag configured to be securely attached to an item and to sense a user's physical interaction with the item in use, the smart tag including: a motion detector configured to detect and differentiate between different types of motion experienced by the smart tag; and a communications engine configured to determine the location of the smart tag within the interaction environment; wherein the communications engine is configured, in use, to transmit interaction information to a receiving device over a short range wireless telecommunications link, the interaction information comprising the location of the smart tag or data enabling the location of the smart tag to be determined, the type of motion experienced by the smart tag over a time period and a unique tag identifier; and a user interaction server remotely located from the interaction environment and connectable to the receiving device via a wide area communications network, the user interaction server being configured to receive the interaction information, the user interaction server being configured to analyse the interaction information to determine the occurrence of a trigger event and in response thereto to carry out a predetermined action.

In some embodiments, the receiving device comprises a mobile telecommunications device and the user interaction server is configured to receive a unique identifier of the mobile telecommunications device. Examples of such mobile telecommunications devices include a smartphone, a tablet computer, portable items of apparel including telecommunications functionality such as a wearable smartwatch or smart glasses.

In various embodiments, the user interaction server is configured to receive a unique identifier of the interaction environment. This enables data from one particular interactive environment advantageously to be distinguished from data from another interactive environment.

The user interaction server may be configured to pair together an item and a smart tag on receipt of an activation signal from an activation device, the activation signal comprising the unique identifier of the smart tag obtained from scanning of a visual representation of the unique identifier provided on the smart tag and an identifier of the item obtained from scanning of a visual representation of the item identifier. In this way, items which have no communications capability can be tracked and interaction with those items can be captured and analysed. In some embodiments, the smart tag can be integrated into the item itself. For example, the smart tag can be integrated into a label of an apparel item (clothing, shoes, and accessories). In the case of clothing, the smart tag can have a long-life battery and can be waterproof/resistant in order to be washable.

In some embodiments, the predetermined action is to activate an electronic visual display in the vicinity of the smart tag to display information regarding the item. In this way, it is possible to increase the amount of information that is available to the user from interaction with an item and also to control how that information is presented and in the most appropriate manner. In one embodiment the user interaction server is configured to determine a direction of travel of the smart tag within the interactive environment and the predetermined action comprises activating an electronic visual display along the direction of travel of the smart tag. This then enables information about the item, for example how it is used, to be displayed on a typically large visual display. It also enables such displays to be provided at discrete locations within the interaction environment so as not to occupy much space and to be activated upon the user moving between locations within the interaction environment. In one embodiment, the electronic visual display comprises a mirrored screen.

This enables the display to be accommodated in a changing room of a retail apparel store for example and provide additional information to the user about the item whilst they are determining whether the item should be purchased. Also, this conveniently enables the display to have multiple purposes thereby saving further space with in the interaction environment.

As mentioned above, the user interaction server is configured to provide to the electronic visual display, additional data regarding the item which is not provided on the smart tag or on a label of the item itself. For example, in some embodiments the additional data comprises a video showing the item in use. When the item is an item of apparel, this can enable the user to see how the item appears when wore in different settings, for example how swimwear would appear when worn on the beach (namely in an environment different from the interaction environment).

In an embodiment, the predetermined action comprises providing to the mobile telecommunications device additional data regarding the item which is not provided on the smart tag or on a label of the item itself. Here the mobile telecommunications device which may be personal to the user, can advantageously receive and store the additional information for the user to consider even after they have left the interaction environment.

Preferably the user interaction server is configured to filter the additional data using personal data about the user. Such filtering enables the additional data to be tailored to the user's preferences and thus provides information which is more likely to be relevant to the user. This has the benefit of reducing the amount of information which is sent to the mobile telecommunications device and which needs to be presented to the user.

The additional data may comprise several different types of data. For example, the additional data can comprise extra information regarding the manufacture or creation of the item; current inventory information and or pricing information; history information relating to the user's online browsing history of items related to the item being interacted with; or information regarding items which have been determined by to be complementary to the item being interacted with.

In some embodiments, the predetermined action is to automatically provide details of the item to a Point of Sale (POS) terminal in order to carry out a purchase transaction of the item within the interaction environment. The trigger event for such a predetermined action is in some embodiments the deactivation or removal of the smart tag from the item or the bringing of the item to a particular location within the interactive environment. This advantageously enables the items to be purchased automatically with minimal interaction and also minimises the time taken to complete the transaction. In such cases the personal information of the user may include details of how they would pay for such items, for example credit card details.

In some embodiments, the system further comprises an application downloaded to the mobile telecommunications device which, in use, configures the mobile telecommunications device to provide personal data about the user to the user interaction server. The personal data can be used to establish a data filter as described above, set up automatic payment details or enable linking of on-line activity (such as browsing) to the offline user interactions with physical items as determined by the system.

The application can be configured to record each of the items which the user has interacted with during the time they have been within the interactive environment. This history may be helpful to the user or to assistants when looking for items or if they wish to return to a previous item which was interacted with. Preferably, the application is configured to display via the mobile telecommunications device, a summary of the items recorded by the application. This visual display makes it very easy to recall and consider a plurality of items that were interacted with over a period of time. Also, the application may be configured to display via the mobile telecommunications device, an online browsing history of the user. This advantageously enables the user activity in the online interaction domain to be compared with the user's activity in the offline interaction domain to be compared or used to assist selection and determination of a specific item to be selected or purchased, for example.

In some embodiments, the user interaction server is configured to maintain a log of the current locations of a plurality of different items within the interaction environment as determined by the locations of smart tags attached to the items. This advantageously enables the user interaction server to not only have a complete inventory of all items within the interaction environment but also to track their movement and location automatically without requiring user intervention. The log also enables items to be located and moved back to a desired location if the item has been moved by the user.

In an embodiment, the user interaction server is configured, in response to receiving an item location request from a mobile requesting device at a first location within the interactive environment, to determine the current location of the requested item using the log and notify the mobile requesting device of the current location of the requested item. This enables the user using the mobile telecommunications device to conduct a search for any item in the interaction environment and to determine its current location. Furthermore, the user interaction server may be configured to provide directions to the mobile requesting device to travel from the first location to the location of the item within the interaction environment. This advantageously enables the user to be directed to the exact current location within the interaction environment of the desired item.

In some embodiments, the user interaction server is configured to receive a wish list of desired items established by the user and to determine the current location of any items on the wish list within the interaction environment using the log and notify the mobile requesting device of the current location of any items on the wish list. In this way the locations of a plurality of items which the user is searching for can be provided to the user to enables them to find the desired items more quickly within the interaction environment. This typically reduces the amount of time of the user within the environment and thereby advantageously increases throughput of users through the interactive environment.

In some embodiments, the user interaction server is configured to use the interaction data to generate a user profile and then use the user profile to select data to send to the user or to create a filter for filtering information to be sent to the user. This is an automated way of creating a data filter based on evidence of user interactions which can be used to filter additional data to be sent to the mobile communication device.

Preferably, the user interaction server is configured to have a store of predetermined trigger event profiles, each trigger event profile identifying a type of user interaction with the item. The trigger event profile may identify one or more of a group comprising: touching an item, scrolling through a rack of items, picking up an item, turning over an item, walking with an item, abandoning/discarding an item, passing the item over to another user, theft of the item. Such trigger events may be expanded upon depending on the functionality required by the user and in fact combinations of different user interactions with other information such as on-line browsing data may be used to create a trigger event.

In some embodiments, the user interaction server is configured to collate the interaction information from a plurality of different users to determine an interaction profile for a particular interaction location. This is useful to determine how the layout of the interaction environment affects user interaction behaviour and also can be used to enable changes in layout to improve throughflow. Furthermore, important information about items of high interest (large amounts of interaction) can be determined to provide valuable data in avoiding bottlenecks with the interaction environment for example increasing the supply of such items to the interaction environment over time. Accordingly, the user interaction server may be configured to use the interaction profile to assess the physical layout of the interaction location and thereafter create a interaction map showing the areas of the physical location which have the specific types of interaction and the amounts of those types of interaction. Furthermore, the user interaction server may be configured to use the interaction profile to carry out an assessment of the level and type of interaction with different types of items in different locations within the interaction environment and generate a dashboard of the results of the assessment.

In some embodiments, the user interaction server is configured to collate a plurality of interaction profiles obtained from a plurality of different interaction locations and to generate a dashboard of results of the collating step. In this way interaction at different locations can be compared and assessed to determine trends in user interaction with items.

In some embodiments, the user interaction is relayed to a further mobile communications device within the interaction area to enable a third party to monitor how the user is interacting with the items within the interaction area, One example of this is a shop assistant who may be able to assist the user find the item that they are looking for. In another example, a security guard may monitor the user interaction with items to more closely monitor a thief's suspicious behaviour. In some situations, the user interaction server is configured to send the additional data associated with the item being interacted with to the further mobile telecommunications device. This can enable the third party to have more information to hand to assist the third party to better interact with the user. More preferably, the user interaction server is configured to send personal data to the further mobile telecommunications device.

The interactive environment may comprise a retail environment, an art installation environment, a warehouse or a user's home. In each of these cases, tracking user interaction can be helpful in understanding how the environment is structured to enables that interaction, the functionality of the item and how often it is interacted with and also the tracking of the item within the environment and how that item can be located quickly.

The smart tag can take various different forms all of which enable it to act as an active device. This means that it includes a processor and a power source as well as a sensor. In some of the embodiments, the motion detector further comprises a motion sensor and a neural network coupled to the motion sensor, the neural network having been trained to recognise different patterns of motion as determined from the motion sensor to represent different types of user interaction with the item to which the smart tag is connected and to output the determined type of user interaction. The use of a neural network (for example an artificial intelligence microchip) allows the smart tag to learn how different types of motion of the item equates to different types of user interaction with the item. This adaptive capability is useful in that items can be different shapes, sizes and weights such that the same type of interaction may result in different types of sensed movement. All of this is accommodated by use of a neural network.

The communications engine may use any form of sort range telecommunications link and advantageously on which uses low amounts of power. In an embodiment, the communications engine is configured to transmit via a Bluetooth communications channel.

The communications engine may be configured to determine the location of the smart tag within the interaction environment using received wireless signals from a plurality of scanners provided at spaced apart fixed locations within the interaction environment. In such an arrangement the communications engine may be configured to transmit the interaction information to the closest one of the plurality of scanners.

In some embodiments, the receiving device comprises a scanner and the scanner is in communication with a smart tag server 22. In other embodiments, the system further comprises a plurality of scanners and a smart tag server 22 operatively connected to the plurality of scanners, wherein the smart tag server 22 is configured to track the movement of the smart tags about the interaction area and communicate with the user interaction server.

Preferably in these embodiments, the smart tag server 22 is configured in use to be in communication with the mobile telecommunications device, to receive a unique identifier of the mobile telecommunications device and transmit the interaction information to the mobile telecommunications device. This enables the identity of the mobile telecommunications device to be determined and used by the user interaction server in the predetermined action it undertakes.

According to another aspect of the present invention, there is provided a method of determining a user's interactions with and item within an interaction environment, the method comprising: providing a smart tag configured to be securely attached to an item and to sense a user's physical interaction with the item in use; detecting and differentiate between different types of motion experienced by the smart tag; determining the location of the smart tag within the interaction environment; transmitting interaction information to a receiving device over a short range wireless telecommunications link, the interaction information comprising the location of the smart tag or data enabling the location of the smart tag to be determined, the type of motion experienced by the smart tag over a time period and a unique tag identifier; and receiving the interaction information at a user interaction server remotely located from the interaction environment, analysing the interaction information to determine the occurrence of a trigger event; and carrying out a predetermined action in response to the trigger event.

In an embodiment the method may further comprise transmitting the interaction information to the user interaction server from the receiving device.

### BRIEF DESCRIPTION OF THE DRAWINGS

Exemplary embodiments of the present invention are now described with reference to the accompanying drawings in which:

FIGS. 1A and 1B are images of exemplary smart tags, which comprise part of embodiments disclosed herein;

FIG. 2 is a schematic block diagram showing a system in accordance with an embodiment of the present invention, the system operates in an interaction environment and includes smart tags of FIG. 1;

FIG. 2A is a flow diagram showing a method of determining user interactions with smart items in accordance with an embodiment of the present invention;

FIG. 3 is an image of a screen of the SA app of FIG. 2 showing a first step in registering the smart tag to the item;

FIG. 4 is an image of a screen of the SA app of FIG. 2 showing a second step in registering the smart tag to the item;

FIG. 5A is an image of a screen of the SA app of FIG. 2 showing a first step in unlocking a smart tag of FIG. 2 from an item;

FIG. 5B is an image of a screen of the SA app of FIG. 2 showing a second step in unlocking a smart tag of FIG. 2 from an item;

FIG. 6 is a screenshot of a dashboard created by the backend server of FIG. 2 showing an analysis of the different types of interactions with items in the store of FIG. 2 and also the locations of the interactions;

FIG. 7 is a schematic diagram showing the user journey through a retail environment (store) and the ways in which the system can interact with the user via the user app of FIG. 2;

FIG. 8 is a schematic diagram showing the user journey through a retail environment (store) and the ways in which the system can interact with the store assistant via the SA app of FIG. 2;

FIG. 9 is a schematic diagram showing a variation of the system of FIG. 2, highlighting the interactions between different components in accordance with an embodiment of the present invention;

FIG. 9a is a schematic flow diagram showing a method of determining user interactions with smart items using the system of FIG. 2;

FIG. 9b is a schematic flow diagram showing a method of determining user interactions with smart items in accordance with another embodiment of the system of FIG. 2;

FIG. 10 is a schematic diagram showing interactions events and the messaging between elements of the system shown in FIG. 9, as a result of an interaction with a smart tag;

FIG. 11 is a schematic diagram showing a security alert being generated from a user interaction with a smart tag in the system of FIG. 9;

FIG. 12 is a schematic diagram showing an indoor location alert being generated from a user interaction with a smart tag using the system of FIG. 9,

FIG. 13A is a series of screenshots of examples of the type of additional information which can be provided to the user's mobile telecommunication device to provide additional information about the item picked up by a user;

FIG. 13B is a series of screenshots showing another example of additional information, namely about items which the user has interacted within the store (namely in-store rather than on-line);

FIG. 14A are screenshots showing an example of recently viewed items whilst browsing on-line selected as an option in the app, and further details of those items;

FIG. 14B is a series of screenshots showing a search function of the app which allows the user to search by day and find the user interactions with items on that day;

FIG. 15A is a series of screenshots of an example of additional information which can be provided to the app, namely a ‘complete the look function’, where the information provided to the user's mobile telecommunications device includes recommendations of complementary items based on what the user has interacted with;

FIG. 15B is a series of screenshots of recently browsed items which the user has interacted with in the store: and

FIG. 16 is a series of screenshots of items of interest in a user's Wishlist.

### DETAILED DESCRIPTION OF EXEMPLARY EMBODIMENTS

The present embodiments are directed to a system which uses smart tags to capture interactions between a user and an item to which the smart tags are attached. The system can note these interactions and take some action as a result of that interaction. There are various different ways in which the system can be configured and in which the method of determining user interactions with smart items can be executed. These different embodiments are described below, at first generally, but then in greater detail with reference to the accompanying figures.

The present embodiments involve the use of a smart tag on an item which includes a motion detector and a short-range (local) communications transmitter (such as a Bluetooth® transmitter). On detection of motion, the smart tag determines the type of interaction associated with the motion and then wirelessly broadcasts a unique identifier locally (for example within 10 metres) together with information representing the type of movement detected over a time period and the current location of the smart tag. This can be considered to be an active broadcast of the information by the transmitted signal. In some embodiments the transmitted signal can be detected by a portable mobile communications device (such as a smartphone) which is in the proximity of the smart tag. The mobile telecommunications device can relay the received message and its unique identifier to a user interaction server (also known as a trigger event server) to analyse the received signal and determine a trigger communication for taking an appropriate action. In some embodiments, this determination is notified back to the mobile telecommunications device and the mobile telecommunications device can then request data relating to the unique identifier to the mobile telecommunications device. Alternative other actions can be carried out by the user interaction server such as generating a display command or generating a security alert. In some embodiments, the data pulled to the mobile communications device may be filtered in accordance with user-specified filters and displayed to the user to provide enhanced information regarding the item which the user has interacted with.

In other embodiments, the transmitted signal from the smart tag can be detected by fixed receivers, or any electronic device which can receive a wireless signal from the short-range transmitter of the smart tag but is in a fixed location within the operating environment, such as a retail store. These types of fixed devices have been referred to as ‘scanners’ hereinafter. In this way, the movement of the smart tag can always be tracked and communication with the tag can be always maintained within the store. Accordingly, it is always possible to locate an item with a smart tag on it no matter what its location within the interaction environment. In these embodiments, the captured user interaction and location of the smart tag can be transmitted to the user interaction server (trigger server) for analysis and determination of a trigger event and the user interaction server can thereafter take the appropriate action in response to the detection of a trigger event.

In some embodiments, the motion detector of the smart tag is a smart motion detector comprising a built-in processor which includes an AI (Artificial Intelligence) functionality, namely a neural network which can be trained to recognise different patterns of motion/positional sensor data and equate that to a particular movement event, such as picking up of the item, inspection of the item, walking with the item, etc. In this embodiment, the result of the analysis by the smart tag, which is communicated to the local portable communications device or the user interaction server to determine whether this movement indicates that a trigger event has occurred such that this captured user interaction with the item can trigger a resultant action. For example, if the smart tag detects a motion of the smart tag, the locations of the smart tag indicate movement towards the exit of the retail space and it is known that the item was taken directly off a hanger, then this may trigger an alarm even before the person gets to the exit, or alert guards to stop that person. The alarm notification can also identify exactly which item is being stolen such that a security guard can be told on own their mobile telecommunications device, what is the item that they should be looking for in the person's bag. A whole set of trigger events have been described herein which could occur as a result of the detected motion event.

In other embodiments the trigger event also generates a response in another device. For example, movement of the item being detected in a particular direction may cause a trigger command signal to be sent to a display device to display a video of the item being worn by a runway model. The display device could be selected from one of several devices positioned about the retail store, as the display which is positioned along the direction the user is walking in such that they will be able to see the display as they approach it. The trigger event can also, in some embodiments, trigger the display of useful information on a mirror in the changing room of a clothes store which could help the user to make the determination of whether or not to purchase the item. For example, the further information could be displayed in the language which the user is most familiar with rather than the language of the country in which the item was being sold and/or could display stock, sizing and pricing information. This personal information may be known from an app (downloaded application) provided on the user's mobile telecommunications device which may be in communications with the user interaction server.

In some embodiments, the trigger event could be to alert a sales assistant to take some action to assist the user. The system may already be aware of the user's particular size as user personal data. This information could be used to provide to the user a correct size of the item matched to their personal data because they may have misjudged the size of the item. Another trigger event could be regarding payment for items in a shopping bag without removal of any items from the bag. As an app on the user's mobile telecommunications device will know whether the item has been placed in the user's bag, due to specific motion detection and know that all the desired items are in a similar location, the app can either automatically, or on request, take payment for those items as the user leaves the store. Alternatively, removal of a smart tag at a point of sale (POS) till or placement of the shopping bag with items to a special purchase location, can result in an automatic debiting of funds from the user's bank account. Both of these features advantageously have the ability to reduce queuing at payment tills and increase flowthrough of users through the store particularly at busy periods.

The location of the smart tag can be determined accurately by scanners provided at fixed known locations around the interaction environment which detect the transmitted signal and hence can accurately determine the location of the smart tag. The location detection can either be determined by the smart tag itself or by the plurality of scanners. This location detection does not require user interaction and so is advantageously automated.

The smart tag can also in some embodiments have an audio-visual detection function. Accordingly, the tag could have a buzzer or a light source (such as a LED) which could be activated by a sales assistant to locate the item. This is particularly helpful when items have been misplaced within a retail store environment by the customers and the positive location identification can help to find those items.

The present embodiments can be used to acquire data relating to user interaction with smart items and to push relevant content to the mobile communications device. Such data could include details about the product, recommendations regarding further complimentary products, such as similar items or even items which are different but are suitable to be combined with the item with which the user is interacting. Taking an example in the retail clothing industry, the item may be a designer shirt which the user has interacted with and the additional information may be other items which are similar by the same designer for example items which are not present physically at the point of interaction. Alternatively, the additional information can be stock information advising the user of the availability of the item in their specific size which may already be known to the app. The interaction can also be used to provide suggestions of other items which may be complimentary to or associated with the item which has been interacted with. For example, the suggestion may be of other items which match the item which has been interacted with. An example in the retail clothing space could be other items of clothing which match the item which has been interacted with. In this case, the app may also present an image of what the user would look like if all those items were selected and worn.

The present embodiments encompass an enhanced security tag for clothing which provides an earlier warning system of unusual user interaction behaviour which can alert a security officer to be alert to a theft of the item from the store. For example, if the pattern of movement detects an item taken off the rail and then being taken directly to the exit of a store, this could trigger a security alert. Alternatively, an attempt to remove the security tag in a changing room, where no cameras are allowed, could be detected and the security officer could question the user on exit from the changing room. It is to be appreciated that the security aspect is not limited to items of clothing. The smart tag could be applied to any item of value within a space, for example a painting or a piece of art in a gallery.

Having generally described the system of the present embodiments, a more detailed description is provided below with reference to an apparel retail environment. However, it is to be appreciated that the present embodiments are not limited to such an environment and can be used in other environments. For example, a system embodying the present invention could also be used in the home environment to track movement of items in a user's closet, provide information about the user's interaction history with that item (how long she's had it, where she's worn it, how she's styled it, resell price, etc).

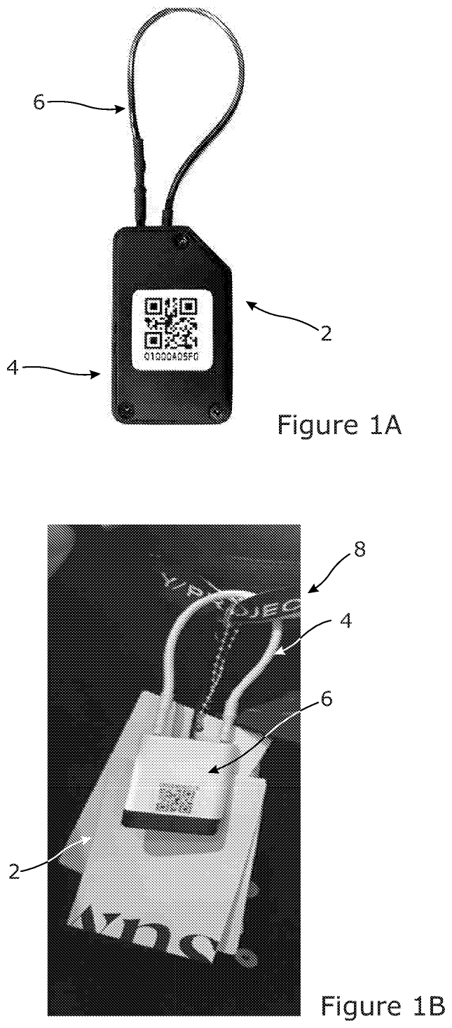

FIGS. 1A and 1B show examples of a smart tag 2 according to embodiments of the present disclosure. The smart tags are relatively small and designed to be fitted to items such as clothing. Each tag has a loop element 4 and a body element 6 which connects both ends of the loop element 4. The loop element 4 is releasably locked to the body element 6. When in an unlocked state, a free end of the loop element 4 can be threaded through a part of the item 8 as is shown in FIG. 1B. The free end is then secured back into the body element 6 when the smart tag 2 is in a locked configuration, in a similar manner to existing security tags. The tag 2 is then not removable from the item 8 without being unlocked from the body element 6.

Whilst not shown, the body element 6 of the smart tag 2 has a battery, one or more motion sensors such as an accelerometer and a gyroscope chip, a processor, a location determining module and a communications engine. The processor may include a neural network as has been described previously. The smart tag 2 also has an LED and a speaker operable by the processor to enable the smart tag 2 to emit light and sounds to enable it to be located easily as required and to confirm interaction if required.

The smart tag 2 is able to sense motion of the item 8 to which the smart tag 2 is connected using the motion sensors. The processor is configured to process the signals from the motion sensor(s) to match the motion signals to a type of movement associated with that type of motion. For example, the processor can match motion signals with a predetermined pattern of motion signals indicative of a user walking with the item. Typically, this pattern matching is carried out by the trained neural network provided within the body portion, such is that the smart tag 2 can match the most likely type of motion to the received sensor signals. Once the processor has determined the type of motion, this can be sent to the communications engine to be broadcast to any receiving device (for example such as the mobile telecommunications device 16 or scanner 14) within the vicinity of the smart tag 2.

The communications engine also determines its current location within the interaction environment 12 in which it is located using the location determining module. This module determines the accurate position of the smart tag 2 by using location scanners 14 positioned around the store such that distance from each location scanner 14 can be used to determine accurately current location. In this regard, any known location technique can be used, for example triangulation techniques and/or trilateration. In one embodiment, Bluetooth® 5.1 is used where Angle of Arrival (AoA) and Angle of Departure (AoD) features provide a direction-finding capability (using triangulation) which enable the location of the smart tag 2 to be determined accurately down to the centimetre (cm) level.

Having determined the precise location and the type of motion of the smart tag 2, the communications engine may use a Bluetooth® connection to transmit interaction information to a mobile telecommunications device 16 and/or a scanner 14 in the vicinity of the smart tag 2. The interaction information comprises the identity of the item, the type of detected motion and the current location of the smart tag 2 or data enabling the location of the smart tag 2 to be determined. Where the smart tag has determined the location itself this data can form part of the interaction information. Where the smart tag does not determine the location (the scanner system for example determining the location of the tag 2), then data enabling the location of the smart tag 2 to be determined can form part of the interaction information.

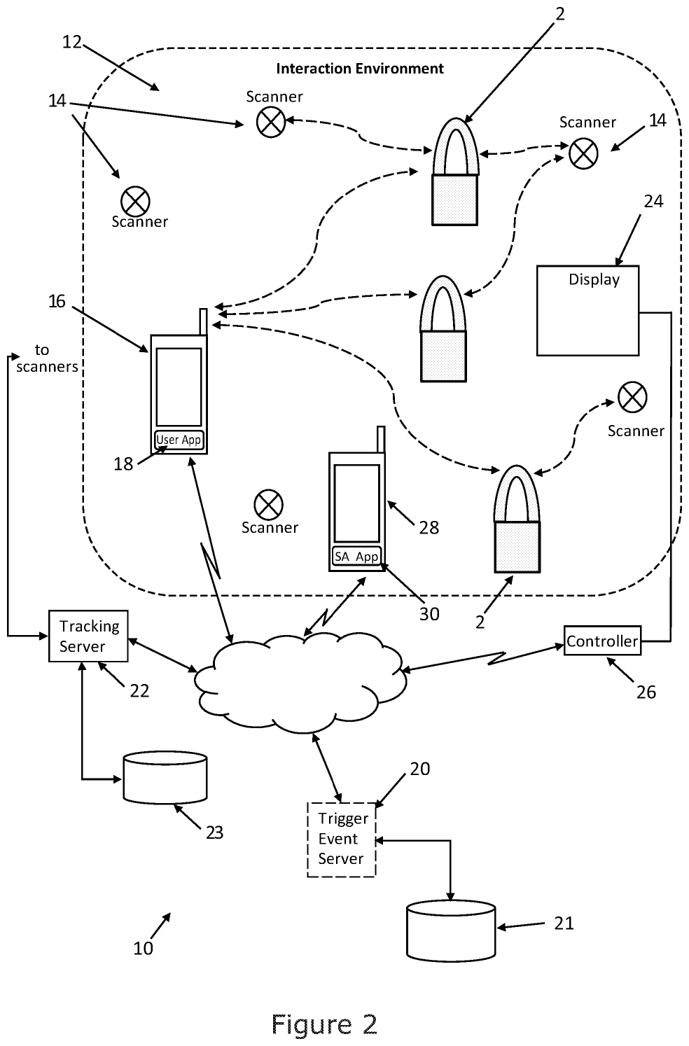

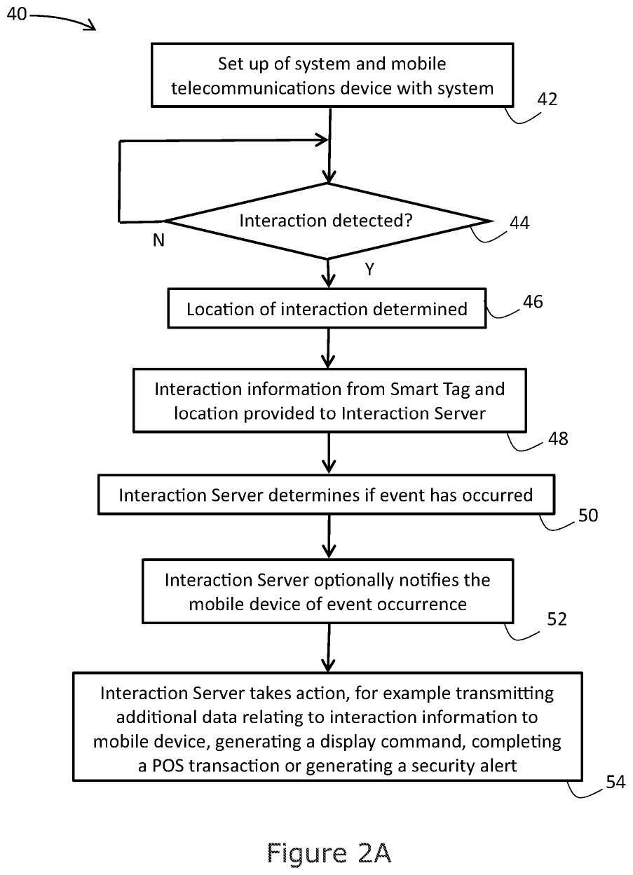

FIG. 2 shows schematically a system 10 in accordance with an embodiment of the present invention. The system 10 operates in an interaction environment 12 a typical arrangement of multiple smart tags positioned around a store (interaction environment 12—delimited by the dotted line). The store 12 also has a plurality of fixed location scanners 14 which enable the smart tag 2 to determine its location within the store. Each of the smart tags 2 broadcasts the interaction information described above locally (in this embodiment via Bluetooth®) and this can be read by a mobile communications device 16 of the user (as shown) and/or by a nearest scanner 14. In one embodiment, the user's mobile communications device 16 has a downloaded user application (app) 18 running on it which can relay the received information to a trigger event server (also referred to as a ‘user interaction server’) 20 with its associate data store 21 to take the appropriate action. The user's mobile telecommunications device 16 can also communicate a tracking server 22 (also referred to as a ‘smart tag server’) with is associated data store 23; identify the item 8 to which this tag is affixed and to specify its location and the way in which it is being interacted with. The tracking server 22 can provide this information to the trigger event server 20 which can then communicate with the mobile communications device of the user to take the appropriate action on the appropriate user's mobile telecommunications device 16. Typically, this action will involve a user's mobile telecommunications device 16 receiving additional data (more detailed information) regarding the item 8 to which the specific smart tag 2 is connected and to making that information available for display in the user app 18. It is also possible for the scanners 14 to communicate with the tracking server 22 to track the movement of and user interaction with items around the store 12 and hence know how an item 8 is being interacted with even if the user does not have a mobile telecommunications device 16. The scanners 14 can be used as an alternative to or in combination with the mobile communications device 16. The embodiment where scanners 14 are used is particularly useful for security embodiments.

Examples of the types of user interactions which the smart tag 2 can detect and transmit to the mobile telecommunications device 16 and/or the scanner 14 are;
Touch item—to see what materials item is made of;
Scrolling through—User browses through a rack but hasn't yet picked up the product;
Picked up—Item is selected and picked up from the rack or shelf;
Turning over—Item is being inspected and turned around;
Walking with—User picks and walks with item to potentially try on or purchase;
Abandoned—Item picked up and left aside, signalling intention to abandon;
Basket change—Item moved between persons e.g. sales associate hands over to the user or vice versa;
Theft—Item is under potential security threat where the tag is being tampered with;

In one embodiment; the system 10 advantageously can provide relevant additional data (detailed information about) the item 8 to the user app 18 running on the mobile telecommunications device 16 automatically; by the user just picking up an item, with no scanning of the tag 2 required. In other embodiments described later, a display 24 in the vicinity of the user can be activated as a result of an action of the trigger event server 20. In some embodiments the display 24 is activated via a controller 26 as the user is walking with the item 8 towards the display 24.

A second mobile telecommunications device 28 is also shown in FIG. 2. This mobile device is the store assistant mobile communications device which is running an SA app 30. The SA app 30 functions to match up inventory (items) to smart tags 2; provide an alarm alert and also to deactivate (unlock/release) the smart tag 2 as required. It can also be sent information enabling the store assistant to provide assistance to the user.

More specifically in one embodiment, once the interaction information has been received by the application (app) 18 running on the mobile telecommunications device 16 (such as a smartphone) this can be used to automatically trigger an event as is described in greater detail below. Use of the user's mobile telecommunications device 16 via an app 18 also advantageously enables the user to call a store assistant and request assistance without the need to find a store assistant. For example, a user may wish to get a different size of item 8 and so can use the app 18 to request this. There is no need for the user to manually identify the item 8 as the interaction with the smart tag 2 will already have provided the required item identification. The app 18 may already know the size of the user from personal data and so the store assistant can use this information to locate the appropriately sized item 8 as well as provide it to the location of the user which will be known from the app 18 and the tracked smart tag 2. Alternatively, the trigger event may be that the item 8 picked up by the user and being taken to the changing room is an incorrect size for the user and the action which results from this trigger event can be to push this information to the sales assistant to provide the correct size garment for the user.

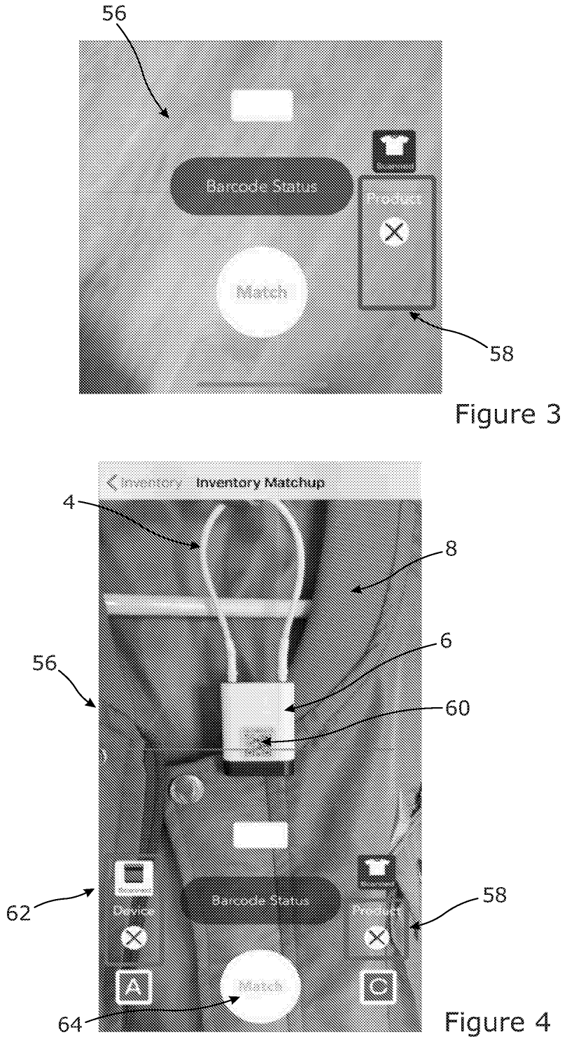

The matching up of specific smart tags to items is carried out by using the camera of the second mobile telecommunications device 28 to scan a QR code on the smart tag 2 and this is described in greater detail later with reference to FIGS. 3, 4, 5A and 5B. In another embodiment (not shown), the information provided by the smart tag 2 can be read by use of a near field device (NFC) sensor as alternative to using the camera of the mobile telecommunications device 28.

Referring now to FIG. 2A, there is shown a high-level flow diagram of a method 40 of determining user interactions with smart items. The method 40 in one non-limiting embodiment is implemented on the system 10 of FIG. 2. In this regard, the system 10 in its broadest aspect is composed of a smart tag 2 and the trigger event server 20 which are configured to communicate interaction data from the smart tag 2 to the trigger event server 20 which can then determine if an event has occurred and take some action. Other elements such as the user interaction app 18 and the scanners 14 and the tracking server 22 can also be part of the system 10, but this is not essential.

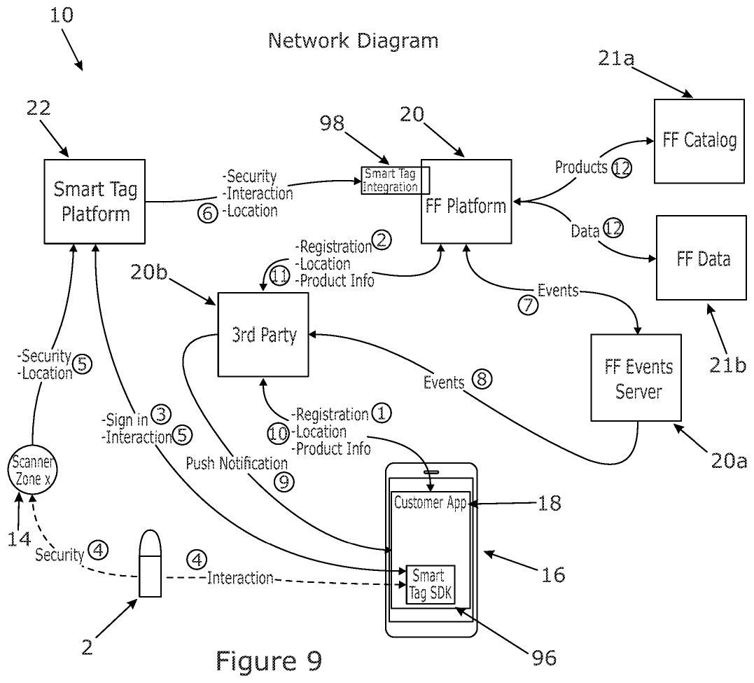

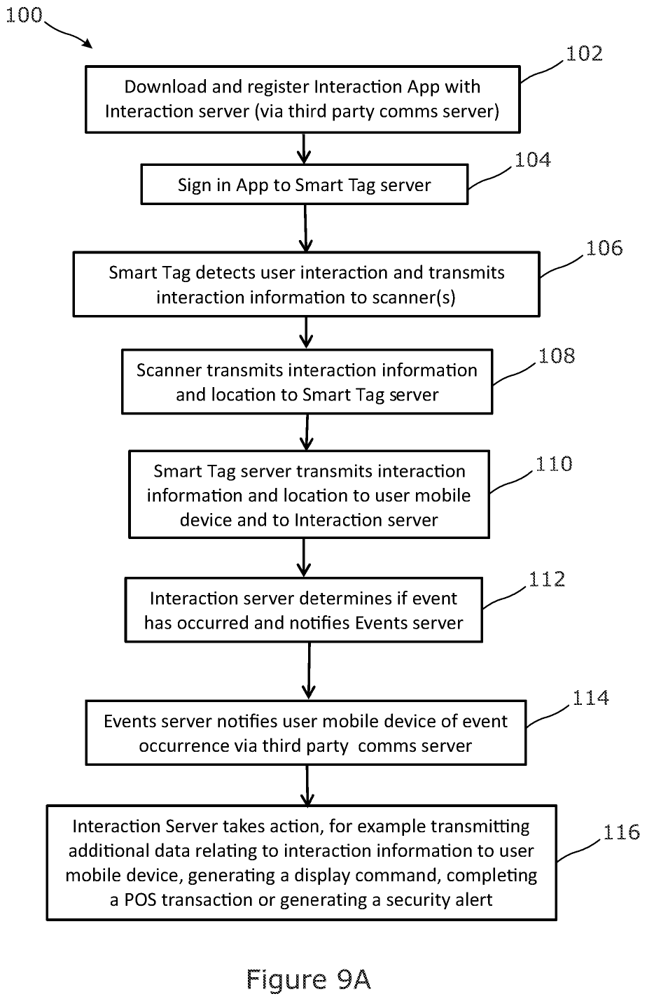

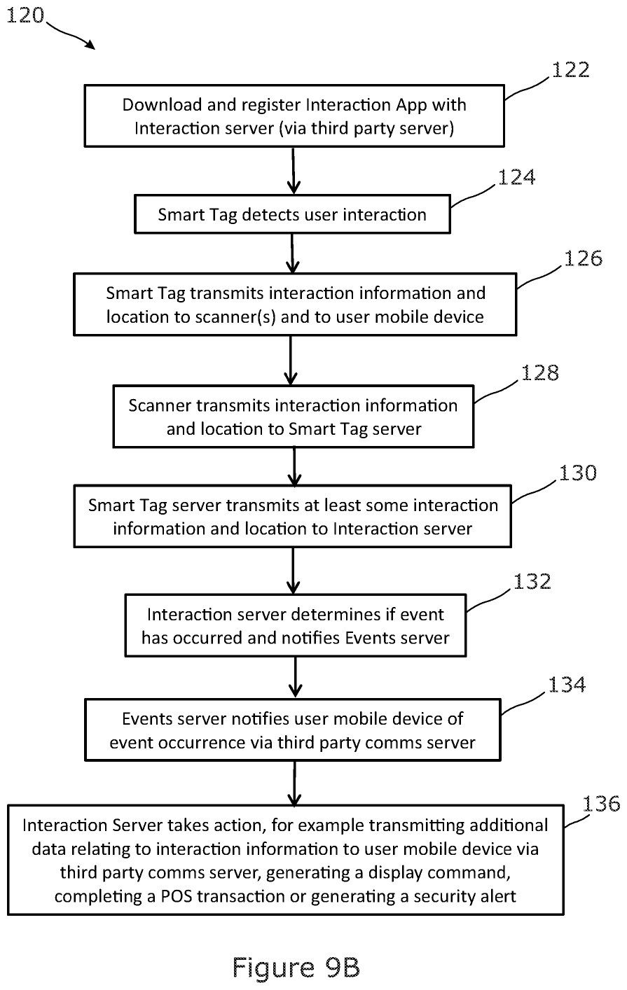

The method 40 commences with the set up, at Step 42, of the system 10 and mobile telecommunications device 16 with the system. This may include downloading of the user app 18, using the app 18 to register the user with the trigger event server 20 and the tracking server 22 attaching and activating smart tags to the items. Once the interaction environment 12 has been configured, the method determines, at Step 44, when an interaction has been detected. Once an interaction has been detected by the smart tag 2, the location of the interaction is also determined, at Step 46. This interaction information is then conveyed at Step 48 to the trigger event server 20 (user interaction server). The manner in which this step is carried out varies from embodiment to embodiment. It can be sent directly via the mobile telecommunications device 16. However, it can also be transmitted via the tracking server 22 using the scanners 14 without including the mobile telecommunications device 16 or including some communication with the mobile telecommunications device 16. These options are described in more detail later with reference to FIGS. 9, 9A, and 9B.

Once the trigger event server 20 has received the interaction data it determines, at Step 50, whether a trigger event has occurred. There are any number of different combinations of data which can be required to indicate a trigger event has occurred and several examples have been provided within this description. It is to be appreciated that those examples are not exhaustive and the system 10 can be configured as required.

Once a trigger event has occurred, the trigger event server 20 has the option to notify, at Step 52, the user's mobile telecommunications device 16 of its occurrent. If for example the action which has been triggered is to activate a display 24 and provide it with a video of the item 8 being used, then there is no need to notify the user's mobile telecommunications device 16. However, if the action which has been triggered is to provide additional data (information) to the user about the item 8, then the user may be provided with a notification on the user's mobile telecommunications device 16 and be asked whether they wish to receive that additional data. In other embodiments this additional data can be provided automatically without providing the user option to pull the data.

The trigger event server 20 then executes, at Step 54, the action. This can by one of a variety of actions such as transmitting additional data relating to the interaction data to the user's mobile telecommunications device 16, generating a display command for a display 24 within the vicinity of the user, completing a POS transaction or generating a security alert.

One of the benefits of the system 10 embodying the present invention, is that users in such a store 12 with smart tags 2 are able to see additional product information which is not able to be provided on the item 8 (as there is a physical limit to the amount of information which can be presented). Another advantage is that this additional data can be updated in real time, for example how popular an item 8 currently is and stock levels and locations of a particular size of that item 8.

The system 10 also enables the capture of data describing how customers are interacting with products in-store, and if this is less than ideal, this data enables changes to positioning and layout of the store to be made for example. In this regard, the user app 18 can digitally track all of the user interaction with one or more items 8 in a store 12 and this can be recorded and then uploaded for later analysis by the trigger event server 20 of the system 10.

The system 10 also allows identification of user needs and an exploration of what information is relevant to the user at the point of interaction with an item 8.

The present embodiment can also be used to supplement actions taken after the user interaction in the store 12. For example, it is known that investing into expensive items often requires a thoughtful evaluation process—and this continues after the user has left the store. In particular, users tend to revisit items of interest on one or more websites after a store visit, by searching for the product name or the designer and category name, to look at prices, further details and images in different angles.

Users often find it useful to see how the item photographs, how it is styled and how it can be worn. This helps them visualise how the clothes flow on a body and how it might fit on them, before deciding to try it on in the fitting room.

Users can also be interested in reading about the designer especially if it is an unfamiliar designer. However, the expected to read more about the collection and the inspiration behind it.

All of this information can be determined and provided to the user in response to a trigger event which in this case would be the user's interaction with a particular item 8 within a store.

Activating the Smart Tag

In order to set up correct operation of the smart tag 2, the sales assistant uses the second mobile telecommunications device 28 which in this embodiment is a smartphone and carries out the following step-up steps:

The smart tag 2 is placed on the product, typically with the loop element being attached next to the price tag.

Next the smart tag 2 is paired with the item 8 to which it is attached. To do this, the assistant opens the SA app 30 and selects ‘Inventory Matchup’ from the home page. The assistant's smartphone now opens its camera and is ready to scan the product barcode.

Then the assistant scans the product barcode using the smartphone camera. The product information, identified by the product barcode, is now connected to the system.

When scanned, an icon 58 representing the product will appear on the lower-right corner of the screen 56 as shown in FIG. 3.

Next the assistant scans the QR Code 60 on the smart tag 2 using the camera of the assistant's smartphone 28.

When scanned, an icon 62 representing the tag will appear on the lower-left corner of the screen 56 as shown in FIG. 4.

The assistant then presses the match button 64 on the smartphone 28 (in the lower center of the screen 56) and the smart tag 2 verifies the pairing by blinking a green light using its LED (not shown).

Multiple items 8 (products) can be paired by repeating the above-described steps.

In an alternative embodiment as mentioned above, the mobile telecommunications device 28 can use an NFC sensor rather than the camera to read the smart tag 2. The smart tag 2 in this embodiment simply has an NFC readable information, which is read by the NFC sensor of the device when the smart tag 2 is brought into proximity of the device 28. This can advantageously speed up the process of interaction between the smart tag 2 and the store assistant device as a general alignment is all that is required rather than a camera alignment to read the QR information from the QR code 60 of the smart tag 2. Accordingly, in this embodiment one single tap can be used to carry out smart tag 2 identification and matching.

Deactivating the Smart Tag

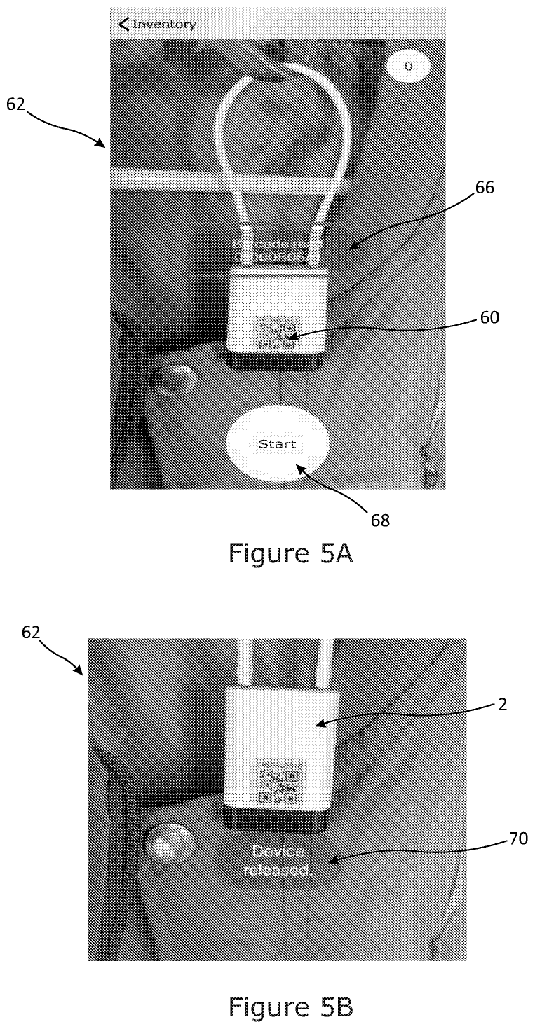

Once the payment for the item 8 has been processed, the SA app 30 on the second mobile telecommunications device 28 can be opened, and the option ‘Device Alarm Deactivation’ can be tapped from the home page. The mobile telecommunications device 28 (a smartphone in this embodiment) then opens its camera and is ready to scan an image. The image of the smart tag 2 with its QR code 60 is taken and scanned. When scanned, the smart tag's ID number 66 appears on the screen 62 of the store assistant mobile telecommunications device 28 as shown in FIG. 5a. Then the assistant taps the ‘start’ button 68 and the device can be deactivated. Upon deactivation, a “Device released.” message 70 appears on the screen 62 of the app 30 as is shown in FIG. 5b. The SA app 30 can communicate the device release signal back to the smart tag 2 which can then unlock the loop element 4 such that the tag 2 can be safely removed/separated from the item 8. In the alternative, NFC embodiment mentioned above, this deactivation process can also be carried out but by using the NFC sensor of the device 28 in place of the QR code 60 being read by the camera of the mobile telecommunications device 28. Advantageously, this speeds up the entire process as just a single tap of the smart tag 2 at the NFC sensor can be used to deactivate the smart tag 2.

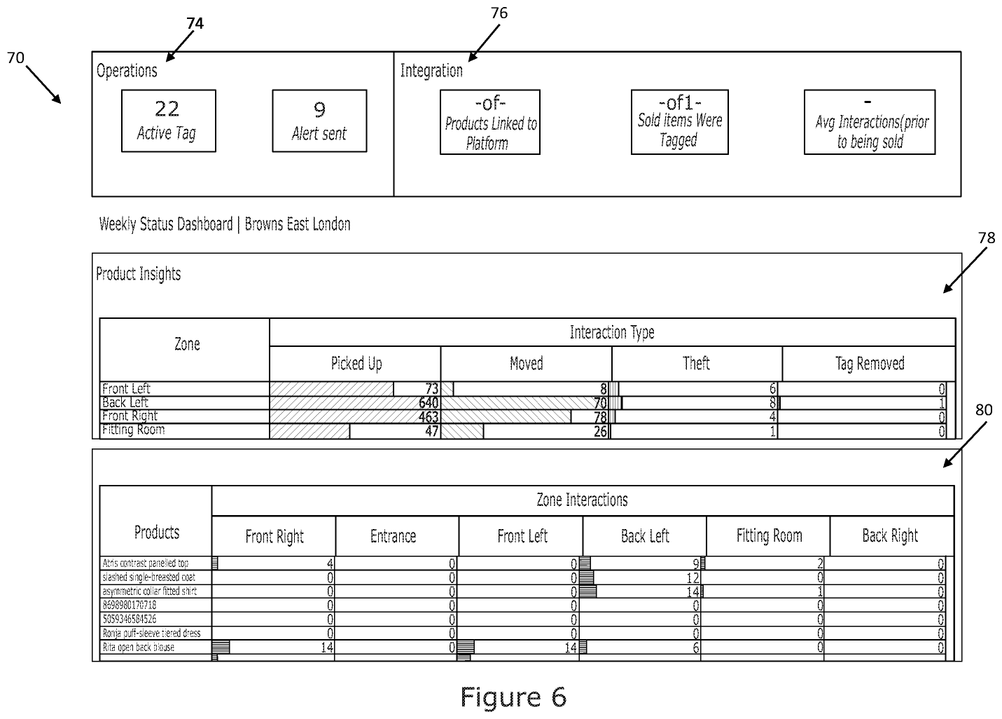

As mentioned earlier all the data collected by the user app 18 from user interactions with smart items within a store can be uploaded to the trigger event server 20 and can be stored in the data store 21 for analysis. This analysis can be carried out in many ways to better understand user interaction with items. FIG. 6 shows a dashboard 70 generated by the trigger event server 20 which shows the result of analysis on a plurality of different user interactions with smart items 8 in a store 12. As can be seen, the dashboard 70 shows four regions, 74, 76, 78, 80. The first region 74 shows a summary of different operations carried out. The second region 76 shows the integration metrics. The third region 78 relates to product insights and is a spreadsheet with different locations (zones) within the interactive environment shown on one axis and the type of interaction with the smart item 8 shown on the other axis. The number of interactions in each zone by their type is thus shown. The fourth region 80 also relates to product insights and is also a spreadsheet with different locations (zones) within the interactive environment shown on one axis and the type of each item 8 (product) shown on the other axis. The number of interactions in each zone by their product type is thus shown. The dashboard 70 enables the regions of interaction and the types of interaction to be distinguished to provide a clearer understanding of the user interaction with the smart items within the interaction space.

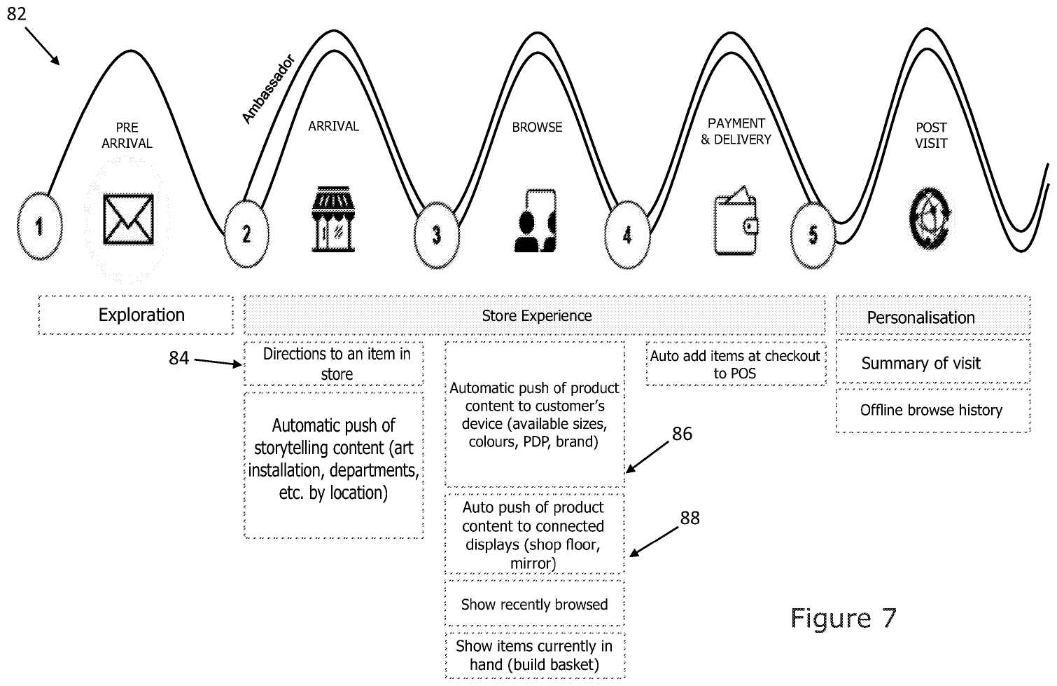

FIG. 7 shows a schematic 82 of a user journey starting from before a store visit to after a store visiting which includes item 8 interactions (items with smart tags). Here the types of actions which can be taken by the system 10 to provide relevant information to the user is shown at different stages of that journey. For example, the action of the trigger event server 20 proving directions to the user's mobile telecommunications device 16 directing the user to a specific location within the interaction environment 12 where a desired item 8 is located is shown at box 84. The actions which the system 10 can also take are shown. For example, at box 86 the push of additional data (content) relating to an item 8 which has been interacted with and at box 88 where content is pushed to a connected display 24 within the interactive environment is shown.

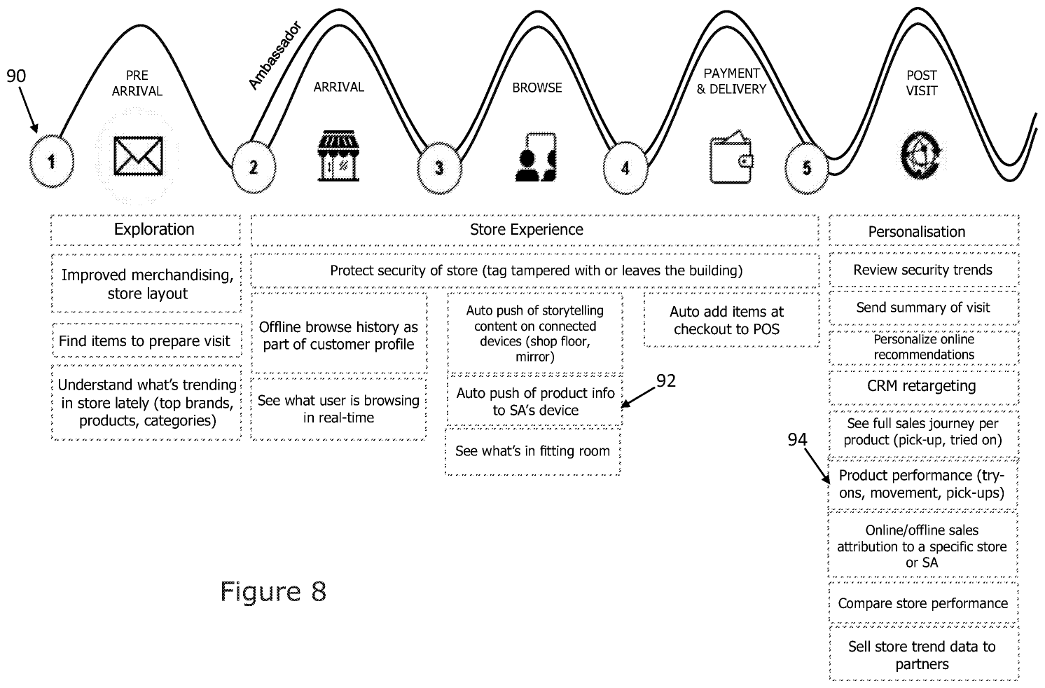

Similarly, FIG. 8 is a schematic 90 of a sales assistant journey regarding the interaction with the smart tags and the users from before a store experience with the user until after. The boxes provided underneath each part of the journey point to the functionality which the system 10 enables the sales assistant to achieve, for example with enhanced security or improved data regarding the user interactions with items in the store. For example, at Box 92 the push of item data (content) relating to an item 8 which has been interacted with to the sales assistant's mobile telecommunications device 28 such that the sales assistant can assist the user and at Box 94 where data analytics are provided to the sales assistant following the departure of the user from the store.

FIG. 9 shows a schematic diagram of another embodiment of the system 10 which highlights the interactions between different components. In this figure, the tracking server 22 has been shown as a smart tag platform and the trigger event server 20 has been shown as a combination of an FF platform, an FF events server 20a and a third-party server 20b.

The FE platform has also been shown connected to other data sources such as an FE catalogue 21a and FE data 21b both of which are represented by the data store 21 in FIG. 2 which is connected to the trigger event server 20.

The mobile telecommunications device 16 shown is a smartphone with a customer app 18 running on it. The customer app 18 includes a smart tag SDK (software development kit) 96. The smart tag SDK is a module of code which runs via the app 18 on the mobile device and enables communications with the smart tag 2 and with the smart tag platform. The customer app 18 is provided by the third party and has a wireless communications link to the third-party server 20b.

The order of interaction between the devices and the components of the system 10 is shown in numbered steps in FIG. 9. These 12 steps are summarised below:
Step 1: The app 18 operating on the user smartphone is registered with the third-party server 20b.
Step 2: The registration is communicated to the FE platform 20.
Step 3: The smart tag SDK 96 in the customer app 18 signs in with the smart tag platform 22. At this point, both the FE platform and the smart tag platform know about the identity of the customer app 18 and how to communicate with the customer app.
Step 4: User interaction with a smart tag 2 is either captured by the sensors in the smart tag 2 and communicated to the customer smartphone and recognised by the smart tag SDK 96 or the smart tag 2 is tracked by the scanners 14 in the store (represented by Scanner Zone X in FIG. 9) which indicates that the smart tag 2 is at a given location.
Step 5: This detection of location may either generate a location alert or a security alert which is then communicated up to the smart tag platform directly from the scanner(s). Alternatively, the customer's direct interaction with the item 8 on which the tag is fitted provides a type of interaction which is then transmitted by the smart tag SDK 96 to the smart tag platform. Optionally, the smart tag SDK 96 can also transmit the location of the interaction with the type of interaction to the smart tag platform.
Step 6: The Smart tag platform 22 then uses the collected data (smart tag 2 location, smart tag 2 identifier, type of interaction and/or security alert) to create a message and sends the message to a smart tag 2 integration module 98 of the FE platform 20.
Step 7: The FE platform 20 then determines whether the type of interaction the customer is having with the item 8 to which the smart tag 2 is connected meets a predefined trigger. If a matching user interaction trigger is matched, this triggers an event which is communicated to the FE Events Server 20a.
Step 8: The Events Server 20a communicates the event to the third-party server 20b with which the customer app 18 is registered.
Step 9: The third-party server 20b then can for certain events send a push notification to the app 18 notifying it that some further information is available if required or some further action can be taken as a result of the captured interaction.
Step 10: If the user wishes to take some action (such as requesting further information about the item) then a message is sent from the customer app 18 to the third-party server 20b for specific information such as additional product information.
Step 11: The third-party server 20b then makes the request for the specific information from the FF platform 20.
Step 12: Finally, the FF platform 20 fetches the required data from either of the FF Data 21b or the FF Catalogue 21a which are both available in the accessible data store 21. This information is then sent back to the requesting customer app 18 via the FF platform 20 and the third-party server 20b.

Referring now to FIG. 9A, there is shown a flow diagram of a method 100 of determining user interactions with smart items. The method 40, in one non-limiting embodiment, is implemented on the system 10 of FIG. 9.

The method 100 commences with the setup, at Step 102, of the system 10 and mobile telecommunications device 16 with the system. This includes downloading of the user app, using the app 18 to register the user with the trigger event server 20 and the tracking server 22 attaching and activating smart tags to the items. Subsequently, the app 18 signs, at Step 104, into the smart tag server 22 (tracking server) and provides the identity of the user's mobile telecommunications device 16. This completes the configuration of the interaction environment 12. Next, the method determines, at Step 106, when an interaction has been detected. Subsequently, the smart tag 2 transmits, the interaction information comprising the type of interaction, the identity of the smart tag 2 and optionally the location of the interaction to the closest scanner 14. The scanner 14 then transmits, at Step 108, the interaction information and the location to the smart tag server 22. The location of the interaction, if not determined by the smart tag 2, is determined by the scanner 14 on the basis of the received wireless signal from the smart tag 2.

The method 100 then continues with this interaction information being transmitted, at Step 110, from the smart tag server 22 to the trigger event server 20 (user interaction server) and the user's mobile telecommunications device 16.

Once the trigger event server 20 has received the interaction data it determines, at Step 112, whether a trigger event has occurred. There are many different combinations of data which can be required to indicate a trigger event has occurred and several examples have been provided within this description. It is to be appreciated that those examples are not exhaustive and the system 10 can be configured as required.

Once a trigger event has occurred as determined by the trigger event server 20, the trigger event server 20 notifies, at Step 112, the events server 20a. The events server in turn notifies, at Step 114, the user's mobile telecommunications device 16 of its occurrence via the third-party server 20b.

The trigger event server 20 then executes at Step 116, the action. This can by one of a variety of actions such as transmitting additional data relating to the interaction data to the user's mobile telecommunications device 16, generating a display command for a display 24 within the vicinity of the user, completing a POS transaction or generating a security alert.

Referring now to FIG. 9B, there is shown a flow diagram of a method 120 of determining user interactions with smart items. The method 120, in one non-limiting embodiment, is implemented on the system 10 of FIG. 9 and is similar in many respects to the method described in relation to FIG. 9A.

The method 120 commences with the setup, at Step 122, of the system 10 and mobile telecommunications device 16 with the system. This includes downloading of the user app, using the app 18 to register the user with the trigger event server 20 (user interaction server) via the third-party server. This completes the configuration of the interaction environment 12.

Next, the method 120 determines, at Step 124, when an interaction has been detected. Subsequently, the smart tag 2 transmits, at Step 126, the interaction information comprising the type of interaction, the identity of the smart tag 2 and, optionally, the location of the interaction to the closest scanner 14 and user's mobile communications device. The scanner 14 then transmits, at Step 128, the interaction information and the location to the smart tag server (tracking server) 22.

The method 120 then continues with at least some of this interaction information being transmitted, at Step 130, from the smart tag server 22 to the trigger event server 20 (user interaction server).

Once the trigger event server 20 has received the interaction data it determines, at Step 132, whether a trigger event has occurred. There are many different combinations of data which can be required to indicate a trigger event has occurred and several examples have been provided within this description. It is to be appreciated that those examples are not exhaustive and the system 10 can be configured as required.

Once a trigger event has occurred as determined by the trigger event server 20, the trigger event server 20 notifies, at Step 132, the events server 20a. The events server in turn notifies, at Step 134, the user's mobile telecommunications device 16 of its occurrence via the third-party server 20b.

The trigger event server 20 then executes at Step 136, the action. This can by one of a variety of actions such as transmitting additional data relating to the interaction data to the user's mobile telecommunications device 16, generating a display command for a display 24 within the vicinity of the user, completing a POS transaction or generating a security alert.

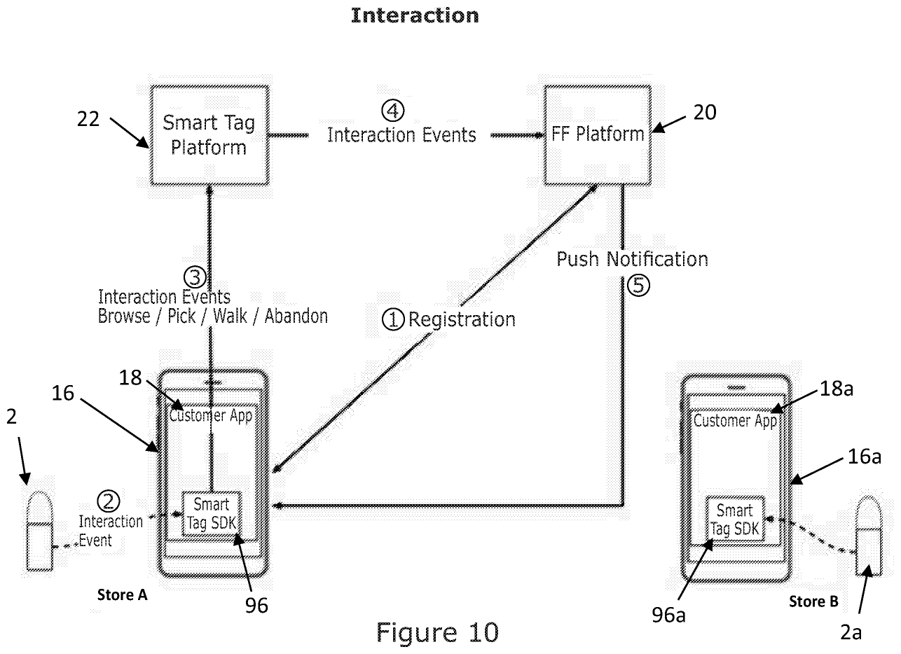

FIG. 10 shows a schematics of user interaction events and how they are handled by the tracking server (smart tag platform/server) 22 and trigger event server (FF Platform/user interaction server) 20; In particular, the steps are shown for a simple interaction with a smart tag 2 at Store A. Here the app 18 registers with the FF Platform 20 directly in Step 1. In Step 2, there is a user interaction with a tag 2 which is transmitted to and captured by the smart tag SDK 96 running with the app 18 on the user's smartphone 16. In Step 3, that user interaction generates a message which is sent to the smart tag platform 22. The message indicates the nature of the interaction event as well as the identity of the smart tag 2 and its current location. At Step 4, the interaction events are sent to and interpreted by the FF platform 20 and an action for a particular customer is generated. The FF platform 20 then sends a specific push notification to the customer app 18 on the smartphone 16 of the user. This push notification is the trigger for one of several different possible subsequent events.

FIG. 10 also shows that the interactions between a smart tag 2a and a user's mobile telecommunications device 16a at another store (Store B) can also be detected in parallel and sent to the same smart tag platform 22 and FF platform 20. The location of the event in this embodiment can also include the store identifier (not shown) such that the system 10 can manage multiple stores at different geographic locations.

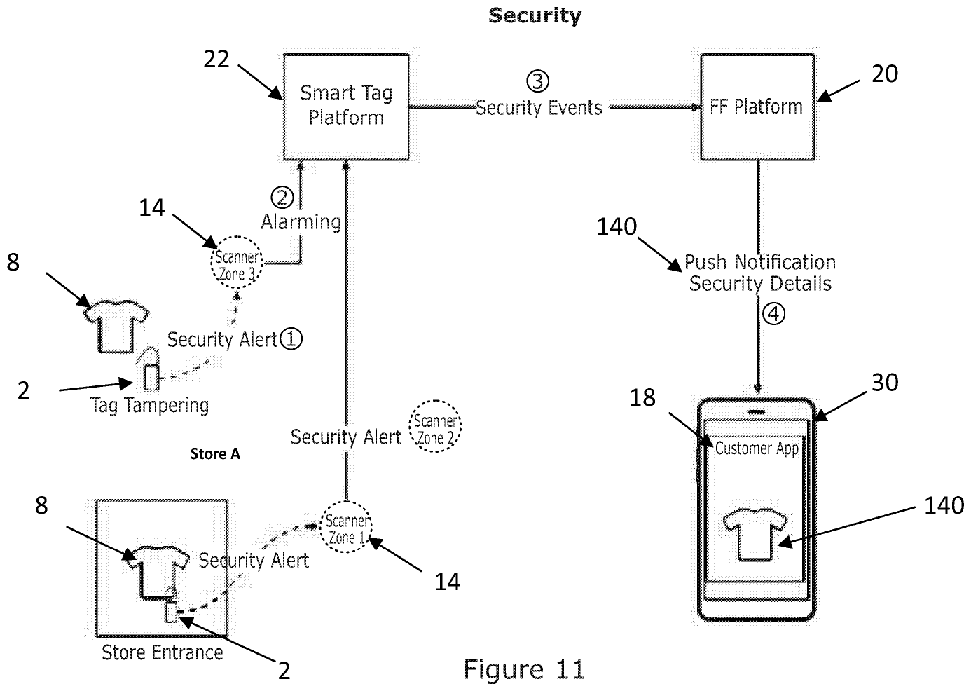

FIG. 11 shows a schematic diagram of a security alert which has been generated by a particular user interaction (movement) being detected by the smart tag 2. The system 10 can detect two different types of security alerts. The first is shown at Step 1, where the smart tag 2 is tampered with which then is sensed by a scanner 14 closest to the current location of the tag, (at Scanner Zone 3 in this example). This in turn generates an alarm message, at Step 2, which is sent to the Smart tag Platform 22. The smart tag platform 22 can also receive a security alert directly from another scanner 14 (in this example positioned at the store entrance of Store A) when the location of the tag 2 passes a particular location (in this case the entrance/exit of the store). The scanner 14 at Scanner Zone 1 detects this and sends the security alert. Regardless of how the smart tag 2 has triggered the security alert, it generates a security event that is sent to the FF platform 20 via the smart tag platform 22. The FF platform 20 determines details 140 of the item 8 which is linked to the tag 2 which generated the security alert. The details 140 of this item 8 are then sent to and displayed on the mobile device 30 of a security guard who then immediately knows the item 8 that they are looking for. This can be very useful where a thief has paid for some goods but not others and mixes the items up in a bag which they try to leave the store with.

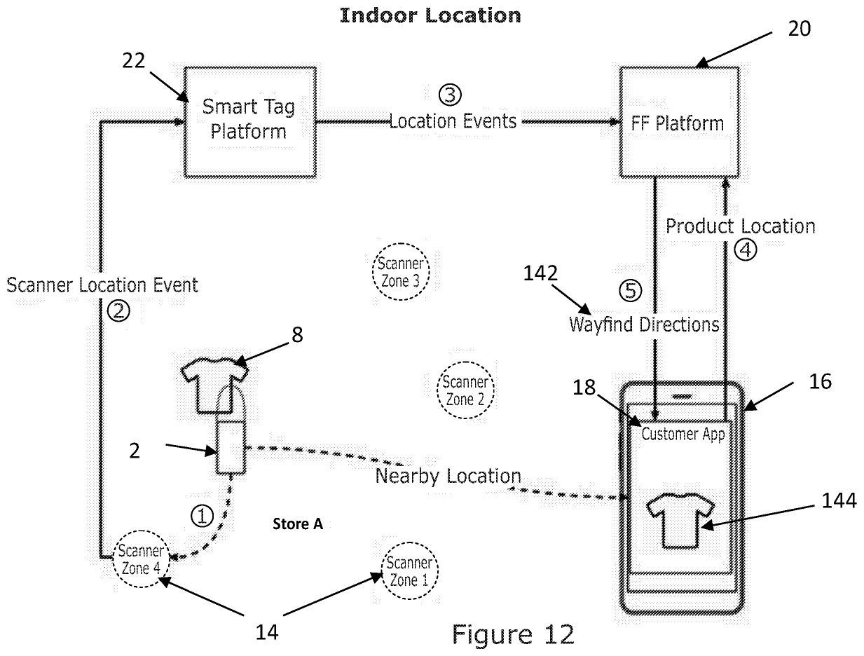

FIG. 12 shows a schematic diagram of an item 8 location detecting functionality of the system 10 which has been generated by a particular user interaction (movement) being detected by the smart tag 2. As is shown at Step 1, the item 8 with the smart tag 2 attached is moved to a particular location and that location is detected by the scanner 14 at Scanner Zone 4. The scanner 14 then sends the location event message to the Smart tag platform 22 which identifies the tag 2 which is at the location proximate to the scanner 14 at Scanner Zone 4. The tag location event is then sent from the Smart tag platform 22 to the FF platform 20. Accordingly, the FF platform 20 always has a picture of the locations of all tagged items 8 within Store A. If at any time the FF platform 20 receives an item 8 location request (at Step 4) then the FF platform 20 can respond at Step 5 with directions to move the customer to the item 8. The item location request typically includes the location of the mobile device 16 making the request and so wayfinder directions 142 can be provided in response to the request to guide the user to the current real time location of product that they are seeking. The user's mobile telecommunications device 16 may also be provided with an image 144 of the item 8 to assist in location of that item.

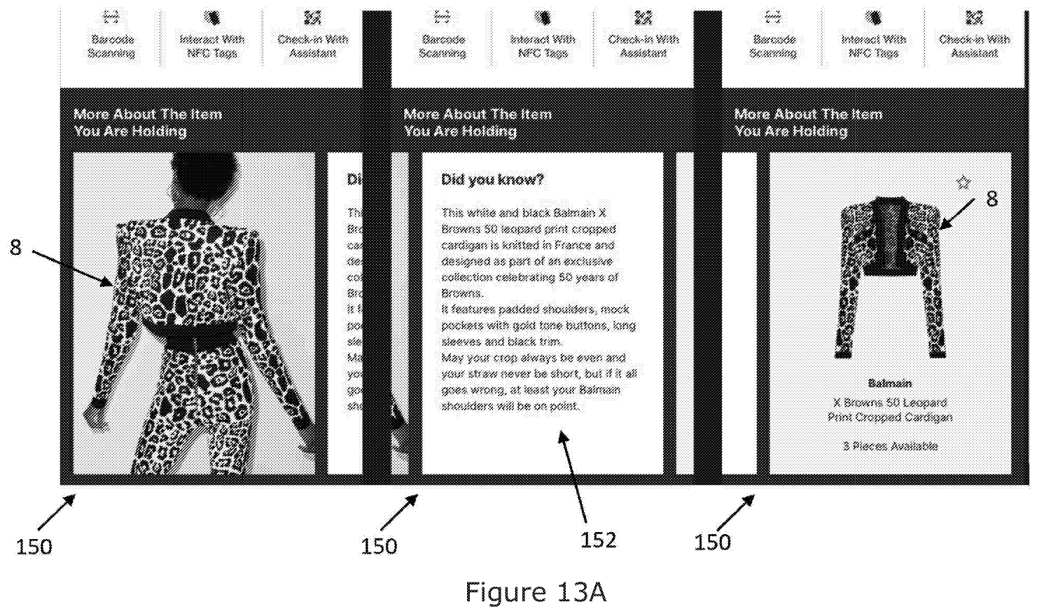

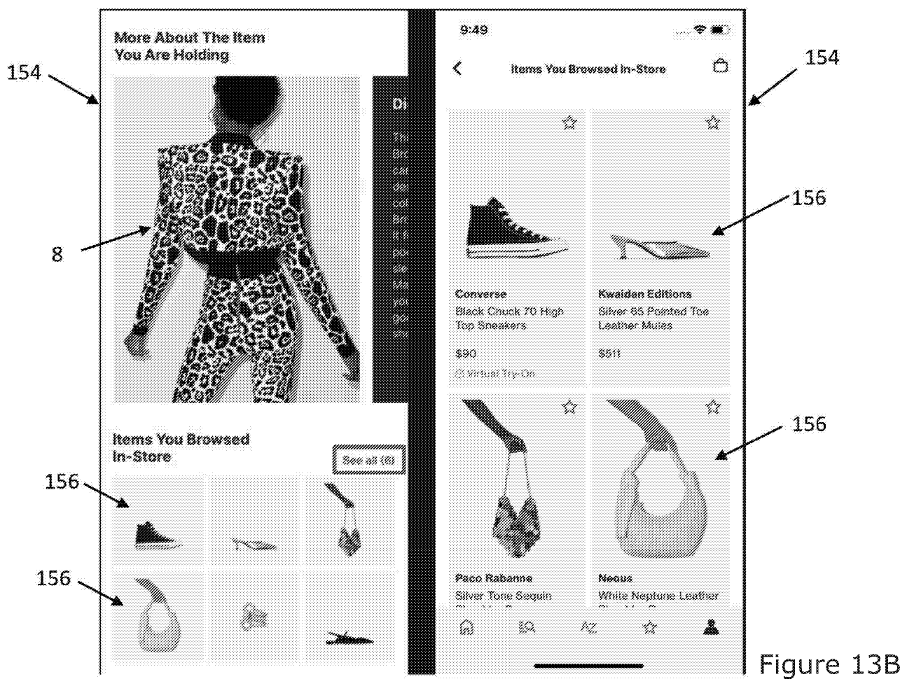

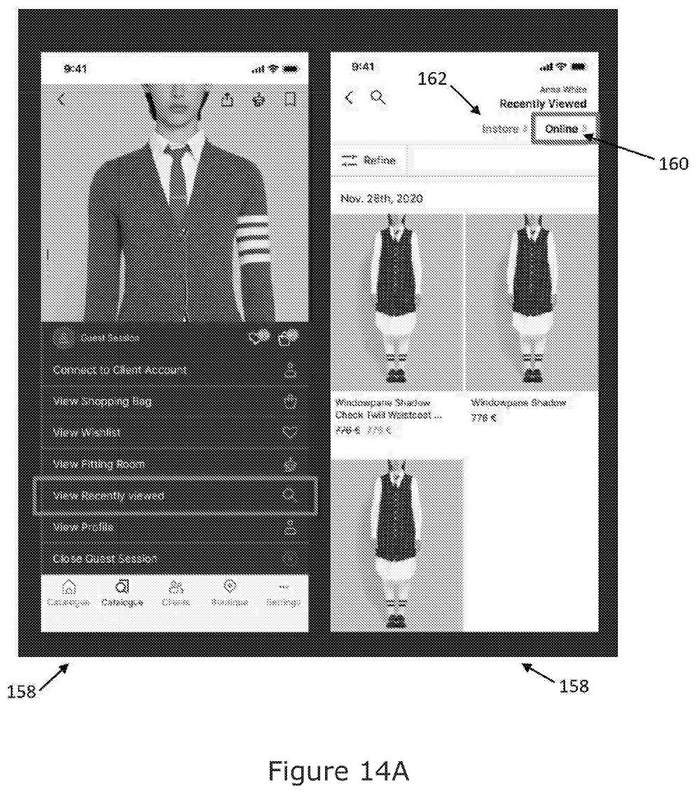

Examples of the types of additional information which can be provided to the user by the event trigger server and how the users interaction can be captured and presented back to the user via the app 18 are now described with reference to FIGS. 13A to 16.

FIG. 13A is a series of screenshots 150 of pages that are presented to the user on their mobile communications device 16 via the app 18. In FIG. 10 additional data (information) about an item 8 a user has interacted with (for example picked up) can also be provided to the user's mobile communications device 16 as part of the push notification or in response to a pull request following the push notification. Picking up the item 8 triggers the presentation of this information on the user's app 18. Here the example screenshots 150 show images of the item of clothing 8 being worn by a model, the item 8 itself and also some background information 152 about the creation of the item 8.

FIG. 13B is a series of screenshots 154 showing not only the item 8 that the user is interacting with currently, but also a collection of items 156 which the user interacted with whilst in the store. The second screenshot shows the items 156 in greater detail. These items 156, or a selection of them, can be added to the user's Wishlist if required.

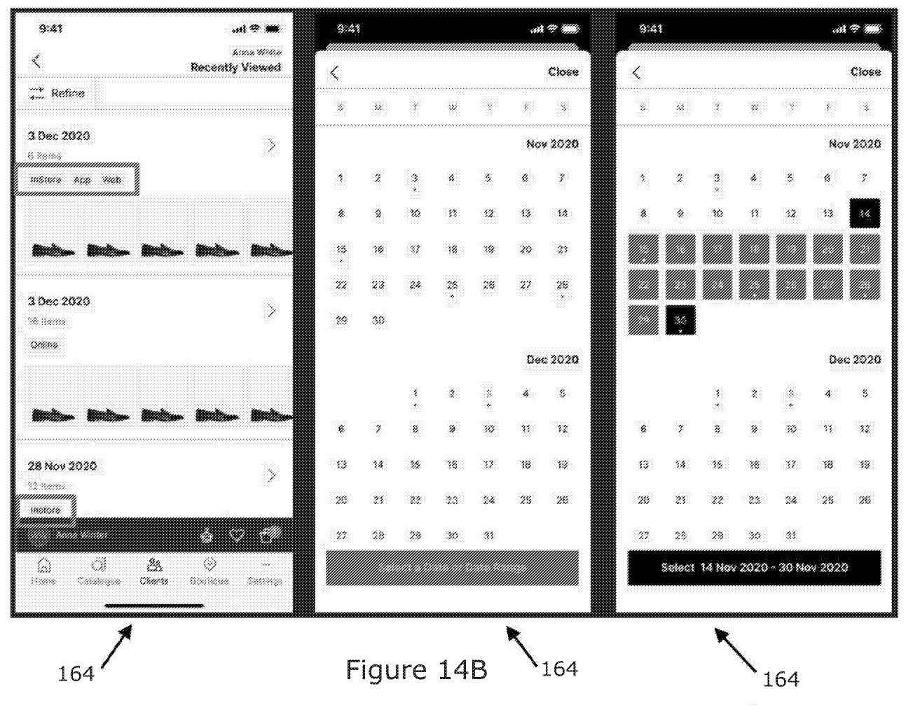

FIG. 14A shows screenshots 158 of an example of recently viewed items whilst browsing on-line. Here recently view items can toggle seamlessly between online items recently viewed 160 and in store items recently viewed 162. In this figure, online 160 is selected as an option in the app 18. Further details of those recently viewed online items can be viewed by selection of this option. Here information is provided from another domain which the user can compare to their instore interactions 162.

FIG. 14B is a series of screenshots 164 showing a search function of the app 18 which allows the user to search by day and find the user interactions with items 8 on that day via the channels of in store, app or on-line. Whilst looking for a specific recently viewed item, all of the dates and interaction domains can be shown in the search results, Different days may provide different interaction channels as results for that same item 8 as is seen in the first screen.

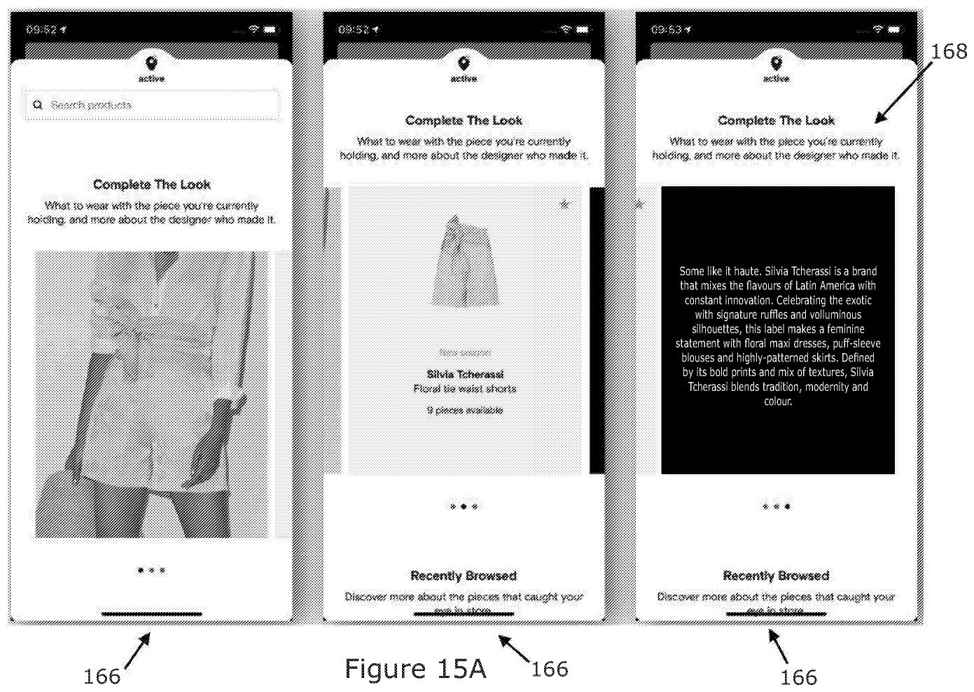

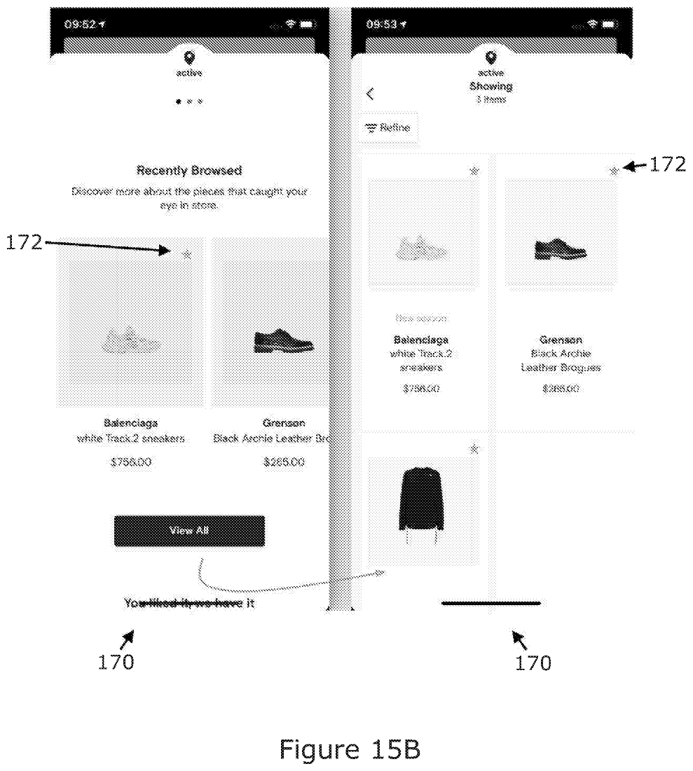

FIG. 15A is a series of screenshots 166 of an example of additional information which can be provide to the app, namely a ‘complete the look function’, where the information provided to the user's mobile telecommunication device 16 includes recommendations of complementary items based on what the user has interacted with. Here, additional information 168 about the designer who made the complementary item 8 is also provided. This helps customers to visualise how clothes may look with other items 8 before deciding to go into the fitting rooms, for example.

FIG. 15B is a series of screenshots 170 of recently browsed items 8 which the user has interacted with in the store. A starred item 172 indicates that that item 8 was on the user's

Wishlist. Having a history of items 8 that a user has interacted with, advantageously enables the user to revisit the item 8 later time to enable them more time to evaluate the item. This history can be helpful in discovering and remembering new designers for example.

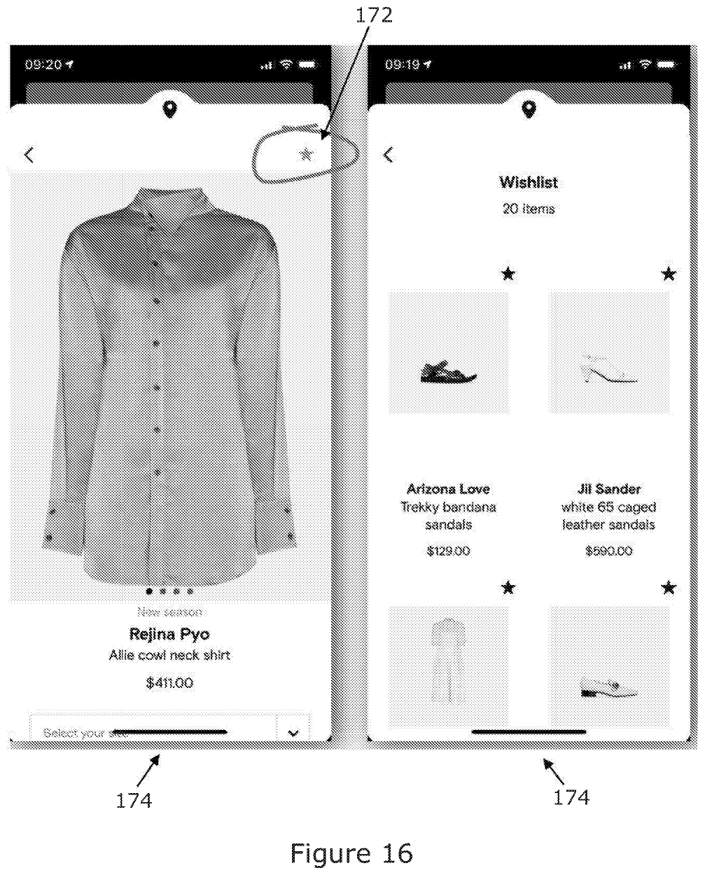

FIG. 16 is a series of screenshots 174 of items of interest in a user's Wishlist. Each item 8 on the Wishlist is starred 172. Having a list of items which a user wants can help in finding relevant items within a store for example as the user can be guided to the location of items on their wish list. Having a Wishlist also helps to share the in-store experience of interaction with items to other users.

Whether the store is a small boutique or large department store, retailers benefit from use of the system 10 because of the data it produces which can be used to power evidence-based decision in layout and behaviour within the store. Examples of specific advantages in the retail environment are:
In-store product journey: build a funnel from warehouse to shop floor zones to fitting room to cashier and sale
Smarter store management: maximise brick-and-mortar real estate for more efficient merchandising and serve as marketing channel
Offline cookie and conversion: measure key metrics at a boutique location or entire brand store network
Key trend insights: collect designer, collection, product data to influence store buying
Omnichannel attribution: track user and product performance to inform customer profile and behaviour

Many modifications may be made to the specific embodiments described above without departing from the spirit and scope of the invention as defined in the accompanying claims.

Features of one embodiment may also be used in other embodiments, either as an addition to such embodiment or as a replacement thereof.

1. A system for determining a user's interactions with an item within an interaction environment, the system comprising:
a smart tag configured to be securely attached to an item and to sense a user's physical interaction with the item in use, the smart tag including:
a motion detector configured to detect and differentiate between different types of motion experienced by the smart tag; and
a communications engine configured to determine the location of the smart tag within the interaction environment; wherein the communications engine is configured, in use, to transmit interaction information to a receiving device over a short range wireless telecommunications link, the interaction information comprising the location of the smart tag or data enabling the location of the smart tag to be determined, the type of motion experienced by the smart tag over a time period and a unique tag identifier; and
a user interaction server remotely located from the interaction environment and connectable to the receiving device via a wide area communications network, the user interaction server being configured to receive the interaction information, the user interaction server being configured to analyze the interaction information to determine the occurrence of a trigger event and in response thereto, to carry out a predetermined action.

2. A system of claim 1, wherein the receiving device comprises a mobile telecommunications device and the user interaction server is configured to receive a unique identifier of the mobile telecommunications device.

3. A system of claim 1, wherein the user interaction server is configured to receive a unique identifier of the interaction environment.

4. A system of claim 1, wherein the user interaction server is configured to pair together an item and a smart tag on receipt of an activation signal from an activation device, the activation signal comprising the unique identifier of the smart tag obtained from scanning of a visual representation of the unique identifier provided on the smart tag and an identifier of the item obtained from scanning of a visual representation of the item identifier.

5. A system of claim 1, wherein the predetermined action is to activate an electronic visual display in the vicinity of the smart tag to display information regarding the item.

6. A system of claim 5, wherein the user interaction server is configured to determine a direction of travel of the smart tag and predetermined action is to activate an electronic visual display along the direction of travel of the smart tag.

7.-15. (canceled)

16. A system of claim 1, wherein the predetermined action is to automatically provide details of the item to a Point of Sale (POS) terminal in order to carry out a purchase transaction of the item within the interaction environment.

17. A system of claim 16, wherein the trigger event is deactivation or removal of the smart tag from the item or the bringing of the item to a particular location within the interactive environment.

18.-21. (canceled)

22. A system of claim 1, wherein the user interaction server is configured to maintain a log of the current locations of a plurality of different items within the interaction environment as determined by the locations of smart tags attached to the items.

23. A system of claim 22, wherein the user interaction server is configured in response to receiving an item location request from a mobile requesting device at a first location within the interactive environment, to determine the current location of the requested item using the log and notify the mobile requesting device of the current location of the requested item.

24. A system of claim 23, wherein the user interaction server is configured to provide directions to the mobile requesting device to travel from the first location to the location of the item within the interaction environment.

25. A system of claim 23, wherein the user interaction server is configured to receive a wish list of desired items established by the user and to determine the current location of any items on the wish list within the interaction environment using the log and notify the mobile requesting device of the current location of any items on the wish list.

26. (canceled)

27. A system of claim 1, wherein the user interaction server is configured to have a store of predetermined trigger event profiles, each trigger event profile identifying a type of user interaction with the item;
wherein the trigger event profile identifying one or more of the group comprising:
touching an item, scrolling through a rack of items, picking up an item, turning over an item, walking with an item, abandoning/discarding an item, passing the item over to another user, theft of the item.

28. A system of claim 1, wherein the user interaction server is configured to collate the interaction information from a plurality of different users to determine an interaction profile for a particular interaction location.

29. A system of claim 28, wherein the user interaction server is configured to use the interaction profile to assess the physical layout of the interaction location and thereafter create a interaction map showing the areas of the physical location which have the specific types of interaction and the amounts of those types of interaction.

30. A system of claim 28, wherein the user interaction server is configured to use the interaction profile to carry out an assessment of the level and type of interaction with different types of items in different locations within the interaction environment and generate a dashboard of the results of the assessment.

31. (canceled)

32. A system of claim 1, wherein the user interaction is relayed to a further mobile communications device within the interaction area to enable a third party to monitor how the user is interacting with the items within the interaction area.

33.-35. (canceled)

36. A system of claim 1, wherein the motion detector further comprises a motion sensor and a neural network coupled to the motion sensor, the neural network having been trained to recognize different patterns of motion as determined from the motion sensor to represent different types of user interaction with the item to which the smart tag is connected and to output the determined type of user interaction.

37. (canceled)

38. A system of claim 1, wherein the communications engine is configured to determine the location of the smart tag within the interaction environment using received wireless signals from a plurality of scanners provided at spaced apart fixed locations within the interaction environment.

39. (canceled)

40. A system of claim 1, further comprising the receiving device, wherein the receiving device comprises a scanner and the scanner is in communication with a smart tag server.

41. A system of claim 1, further comprising a plurality of scanners and a smart tag server operatively connected to the plurality of scanners, wherein the smart tag server is configured to track the movement of the smart tags about the interaction area and communicate with the user interaction server.

42. (canceled)

43. A method of determining a user's interactions with and item within an interaction environment, the method comprising:
providing a smart tag configured to be securely attached to an item and to sense a user's physical interaction with the item in use;
detecting and differentiating between different types of motion experienced by the smart tag;
determining the location of the smart tag within the interaction environment;
transmitting interaction information to a receiving device over a short-range wireless telecommunications link, the interaction information comprising the location of the smart tag or data enabling the location of the smart tag to be determined, the type of motion experienced by the smart tag over a time period and a unique tag identifier; and
receiving the interaction information at a user interaction server remotely located from the interaction environment,
analyzing the interaction information to determine the occurrence of a trigger event; and
carrying out a predetermined action in response to the trigger event.

44. (canceled)

45. A system for determining a user's interactions with an item within an interaction environment, the system comprising:
a smart tag configured to be securely attached to an item and to sense a user's physical interaction with the item in use, the smart tag including:
a motion detector configured to detect and differentiate between different types of motion experienced by the smart tag; and
a communications engine configured to determine the location of the smart tag within the interaction environment; wherein the communications engine is configured, in use, to transmit interaction information to a receiving device over a short range wireless telecommunications link, the interaction information comprising the location of the smart tag or data enabling the location of the smart tag to be determined, the type of motion experienced by the smart tag over a time period and a unique tag identifier; and
a user interaction server remotely located from the interaction environment and connectable to the receiving device via a wide area communications network, the user interaction server being configured to receive the interaction information, the user interaction server being configured to analyze the interaction information to determine the occurrence of a trigger event and in response thereto, to carry out a predetermined action,
wherein the receiving device comprises a mobile telecommunications device and the user interaction server is configured to receive a unique identifier of the mobile telecommunications device, and wherein the predetermined action comprises providing to the mobile telecommunications device additional data regarding the item which is not provided on the smart tag or on a label of the item itself.

46. A system of claim 45, wherein the user interaction server is configured to filter the additional data using personal data about the user.

47. A system of claim 45, wherein the additional data comprises extra information regarding the manufacture or creation of the item, and the extra information comprises history information relating to the user's online browsing history of items related to the item being interacted with.

48. A system of any of claim 45, wherein the additional data comprises extra information regarding the manufacture or creation of the item, and the extra information is regarding items which have been determined by to be complementary to the item being interacted with.

49. A system of claim 45, wherein the user interaction is relayed to a further mobile communications device within the interaction area to enable a third party to monitor how the user is interacting with the items within the interaction area, and wherein the user interaction server is configured to send the additional data associated with the item being interacted with to the further mobile telecommunications device.
